(19) United States
(12) Patent Application Publication
(10) Pub. No.: US 2006/0057865 A1
(43) Pub. Date: Mar. 16, 2006

(54) Electric output structure for a multi-layer power supply

(76) Inventors: Yung-Hsin Huang, Taipei Hsien (TW); Chun-Lung Su, Taipei Hsien (TW)

Correspondence Address: BIRCH STEWART KOLASCH & BIRCH, PO BOX 747, FALLS CHURCH, VA, 22040-0747, US

(21) Appl. No.: 10/939,370

(22) Filed: Sep. 14, 2004

(51) Int. Cl. H01R 12/00

(52) U.S. Cl. 439/61

(57) ABSTRACT

An electric output structure for a multi-layer power supply to integrate electricity for electric processing circuits of a plurality of power supply devices connected electrically to a circuit board. The electric output structure includes an electric bridge which has terminals electrically connecting to the electric processing circuits and a linking section connecting to the terminals. The terminals or linking section has at least one fastening section fastenable to a corresponding coupling section of a fastening terminal formed on a power cord through a retaining member. Thus the power supply connection ports on the circuit board may be increased without adding the electrical coupling circuit to facilitate changing of the power cord.

### FIELD OF THE INVENTION

The present invention relates to an electric output structure for a multi-layer power supply and particularly to a structure adopted for use on a circuit board which couples electrically with a plurality of power supply devices to integrate electric output.

### BACKGROUND OF THE INVENTION

Power supply is an important electric conversion element on electronic equipment. With continuous advances of electronic technologies and well developed Internet and multimedia technologies, the technology of power supply to provide steady electric output also has to progress. As the design cost and technology level of the high capacity power supply are higher, multi-layer power supply that adopts stacking layers or a parallel structure has been developed. Some of them have been integrated to become a high capacity parallel power supply and a backup power supply.

Refer to FIGS. 1 and 6, for a conventional multi-layer power supply device 50 to couple electrically with a circuit board 10. The circuit board 10 has a plurality of power supply connection ports 11a and 11b to couple with a plurality of power supply devices 50. The power supply connection ports 11a and 11b have respectively an electric processing circuit 12a and 12b, and a radiation vent 13 located between the electric processing circuit 12a and 12b. The electric processing circuit 12a and 12b integrate electricity through an electric bridge 20. There is an electric conversion circuit 14 located on a lower side of the circuit board 10 that has electric coupling holes 141 to connect to power cords 30. Such a structure has the following disadvantages pending to be improved:

1. The electric output power required by electronic equipment increases constantly, but many electronic equipment have fixed industrial specifications, such as 2U or 3U servers that are defined by an industrial specification at the dimension of 19 inches width and 1.75 inches height. As the circuit board 10 must have electric conversion circuits 14, the number of the power supply connection ports 11a and 11b is limited, and the space is not fully utilized. Due to the output voltage power of every electronic equipment is different, once the number of the power cords 30 to be coupled exceeds the maximum number of the coupling holes 141, there is no room for expansion. It becomes a problem for users.

2. The conventional electric bridge 20 and the power cords 30 are initially connected by soldering. The power cords 30 tend to soften or even damage at high temperature due to their material characteristics. Soldering also is a troublesome process. Moreover, as new specifications of electronic equipment are developed, the specification and length of the power cords 30 also change constantly. When the existing power supply has to be removed for use on an electronic equipment of a new specification, the power cords 30 have to be replaced. The conventional approach is to redo the soldering process. It requires special soldering equipment and skills that are not affordable by most users. Short circuit occurs if the soldering were not done properly.

### SUMMARY OF THE INVENTION

Therefore the primary object of the present invention is to solve the aforesaid disadvantages. The present invention provides a design that does not have electric conversion circuits on the circuit board and has an extra space to accommodate more power supply connection ports to couple with power supply devices to facilitate changing of power cords. In one aspect, the invention provides an electric output structure to integrate electricity of electric processing circuits of a plurality of power supply devices connecting electrically to a circuit board. The electric output structure has an electric bridge with terminals connecting electrically to the electric processing circuits and a linking section connecting to the terminals. The terminals or the linking section have one or more fastening section. The power cord has a fastening terminal with a coupling section corresponding and fastening to the fastening section through a retaining member, thereby the power supply connection ports on the circuit board may be increased without adding electric coupling circuits to facilitate changing of power cords.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a circuit board for connecting electrically to a conventional multi-layer power supply.

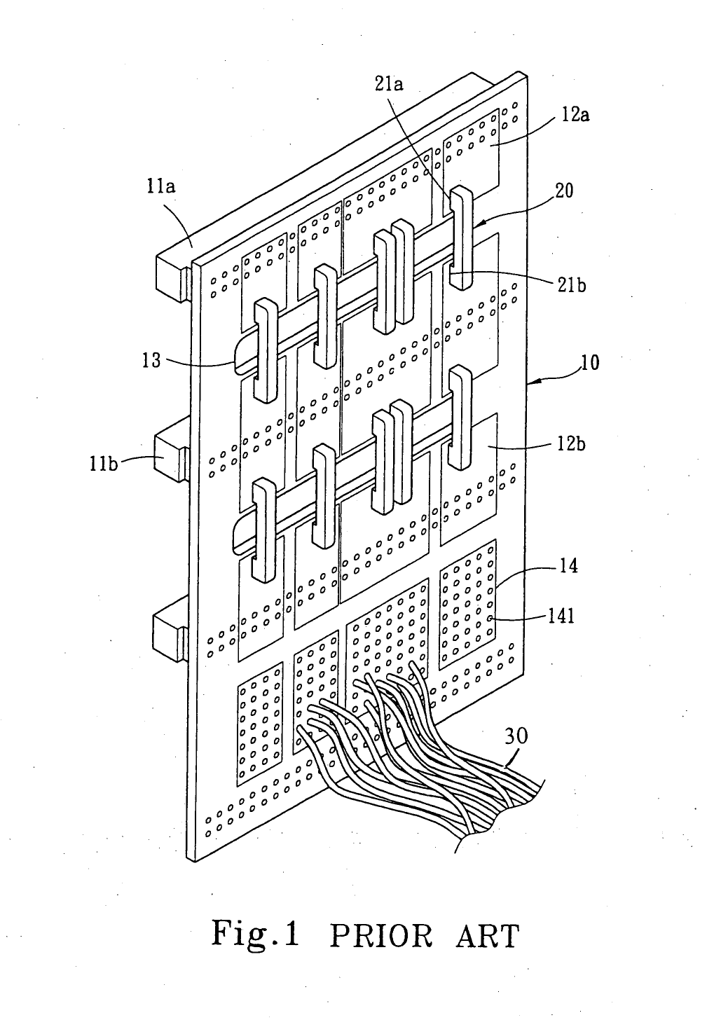

FIG. 2 is a front perspective view of the present invention.

FIG. 3 is a rear perspective view of the present invention.

FIG. 4 is a schematic view of a first embodiment of the electric output structure of the invention.

FIG. 5 is a schematic view of a second embodiment of the electric output structure of the invention.

FIG. 6 is a schematic view of the invention coupling with a power supply.

FIG. 7 is a schematic view of a third embodiment of the electric output structure of the invention.

### DETAILED DESCRIPTION OF THE PREFERRED EMBODIMENTS

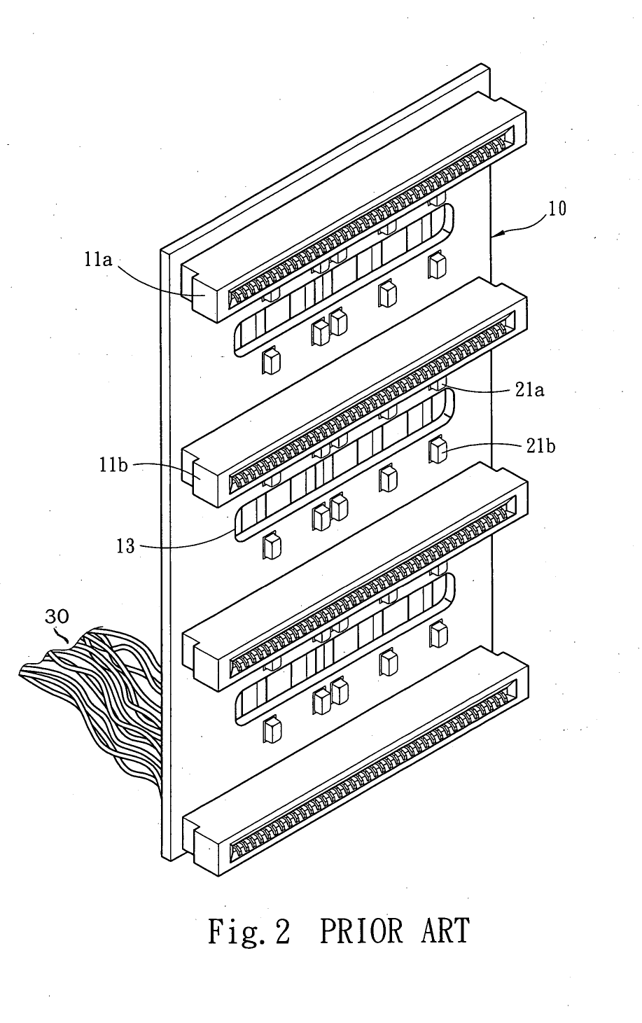

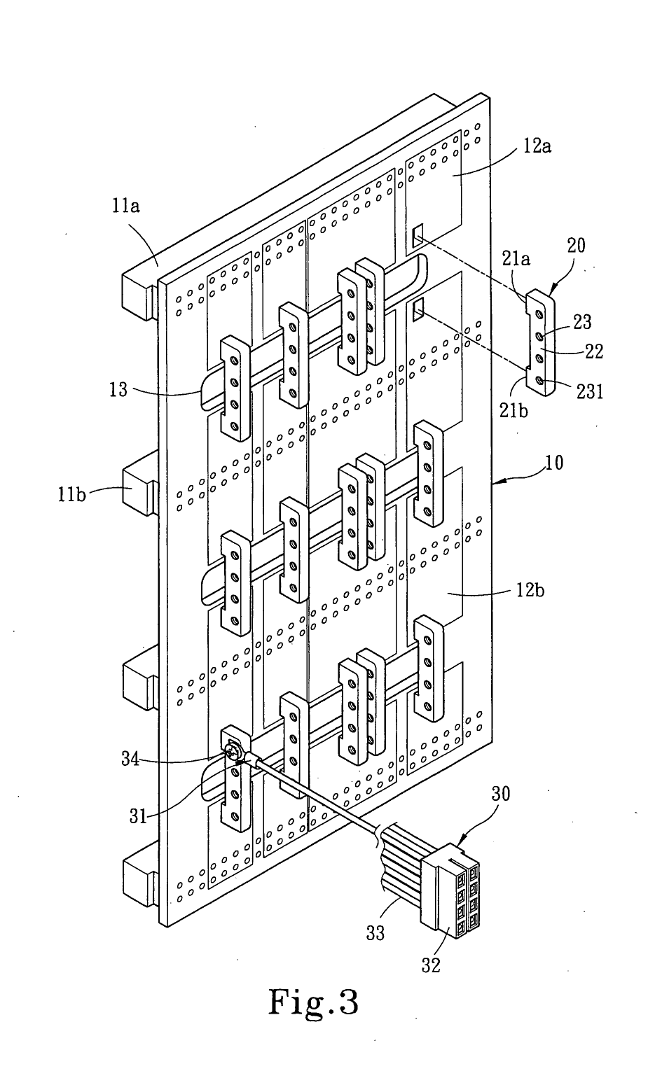

Please refer to FIGS. 2, 3, 4 and 6, the present invention aims to mount a plurality of power supply coupling ports 11a and 11b onto a circuit board 10 to electrically connect to a plurality of power supply devices 50. The power supply coupling ports 11a and 11b have respectively an electric processing circuit 12a and an electric processing circuit 12b with a radiation vent 13 formed between the two neighboring electric processing circuits 12a and 12b. The electric processing circuits 12a and 12b are integrated through an electric output structure to output electricity. The electric output structure includes at least one electric bridge 20 and a power cord 30 connecting to the electric bridge 20.

The electric bridge 20 has terminal 21a and 21b to electrically connect to the electric processing circuits 12a and 12b and a linking section 22 which connects the terminals 21a and 21b. The terminals 21a and 21b or the linking section 22 has one or more fastening section 23. The terminals 21a and 21b are soldered on the electronic circuit of the circuit board 10 by soldering.

The power cord 30 includes a fastening terminal 31, an electric output head 32 and a signal line 33 connecting the fastening terminal 31 and the electric output head 32. The electric output head 32 may be coupled with a plurality of signal lines 33 and fastening terminals 31. Each fastening terminal 31 has a coupling section 311 corresponding and fastening to the fastening section 23 through a retaining member 34. The fastening section 23 has internal screw threads 231. The retaining member 34 has external screw threads 341.

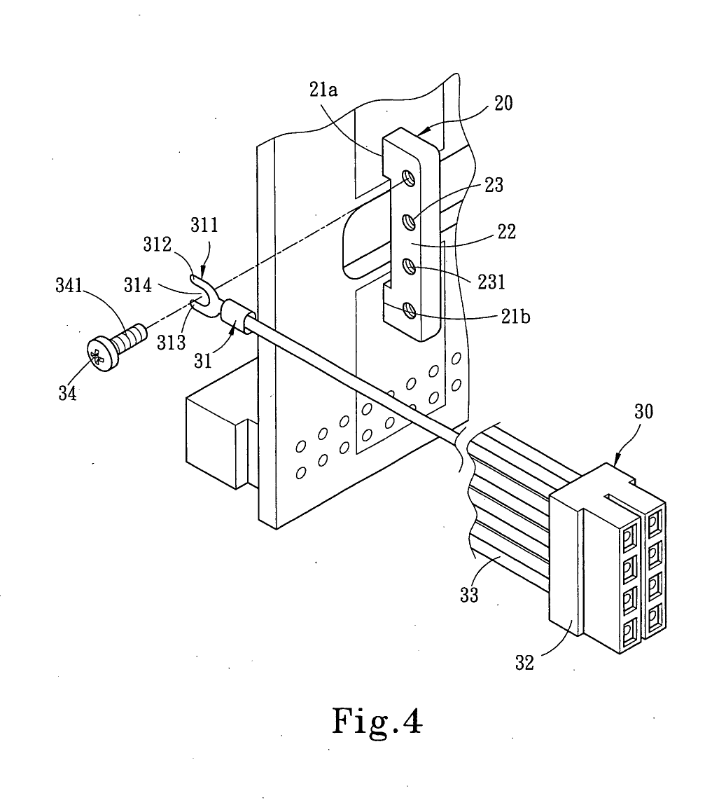

Refer to FIG. 4 for a first embodiment of the invention. When the signal line 33 of the power cord 30 is too short or the electric output head 32 has to be changed, the fastening terminal 31 and the fastening section 23 may be easily disengaged by unfastening the retaining member 34 through a screw driver that is coupled with a fastening zone 314 formed between two legs 312 and 313 of the coupling section 311. Thus the electric connection between the power cord 30 and the electric bridge 20 may be disengaged. Re-connection may be accomplished by fastening the retaining member 34 to the coupling section 311 through the fastening zone 314 and compressing the two legs 312 and 313 so that the power cord 30 and the electric bridge 20 may be connected electrically again. Therefore change of the power cord 30 is easier.

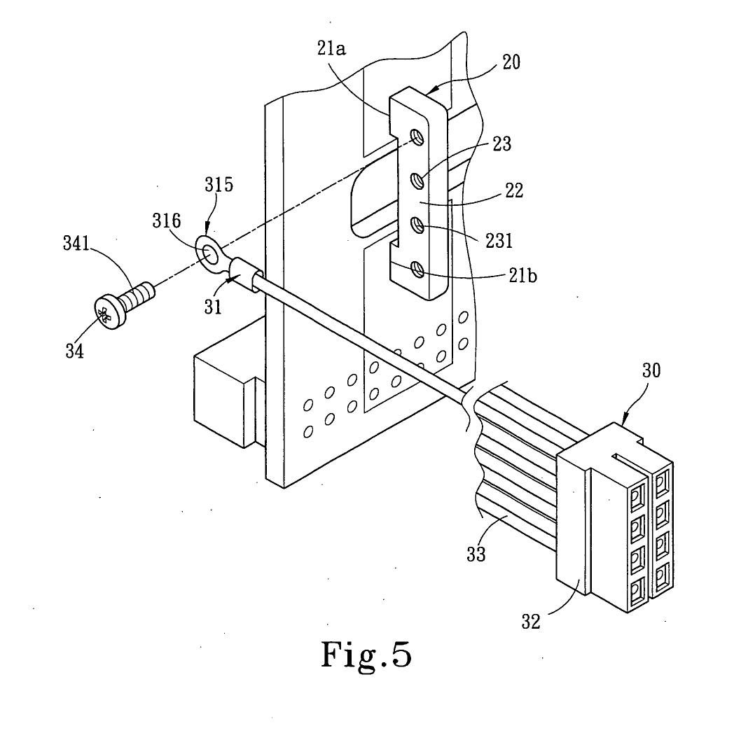

Refer to FIG. 5 for a second embodiment of the invention. It differs from the first embodiment by having the coupling section 311 formed in an annular ring 315 with an aperture 316 in the center to couple with the retaining member 34. The rest is substantially same as the first embodiment. It is to be noted that the electric bridge 20 may be expanded corresponding to the number of the power cords 30 by increasing the width of the linking section 22 thereby to increase the number of the fastening section 23. It has a greater expandability than the conventional technique that provides the coupling holes 141.

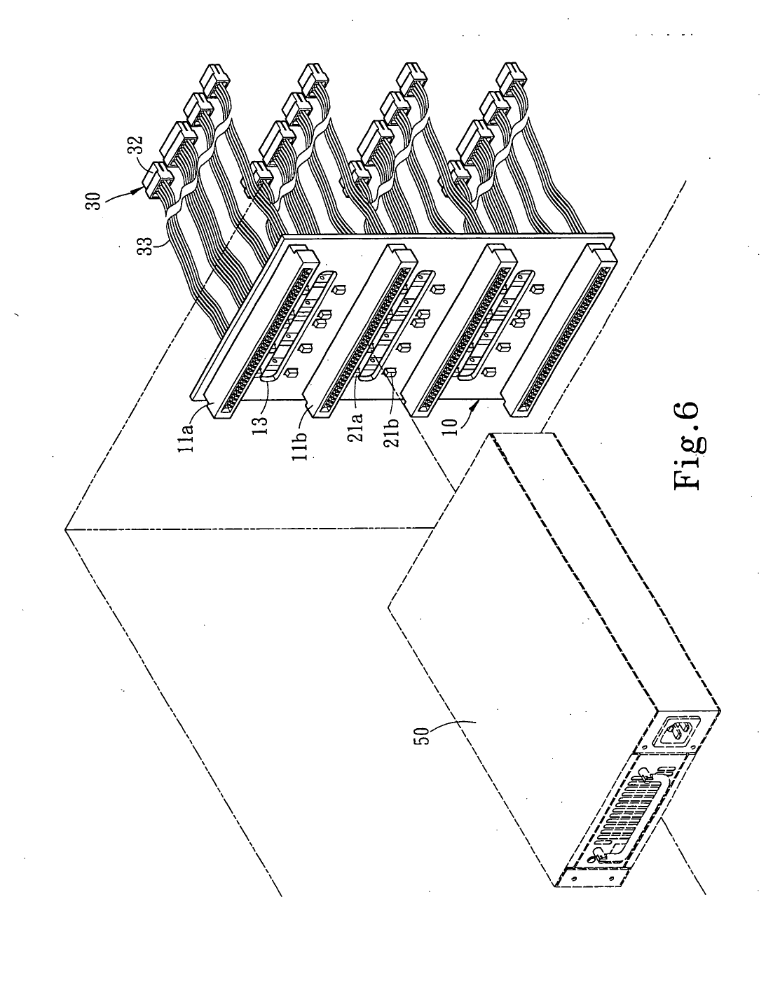

Refer to FIG. 6 for the invention coupling with a power supply device 50. As shown in the drawing, there is no need to add extra electric conversion circuits 14 on the circuit board 10. The spared space can accommodate another set of power supply coupling ports 11a and 11b to connect to an additional power supply device 50. Thus the number of the power supply device 50 may be increased in a limited space.

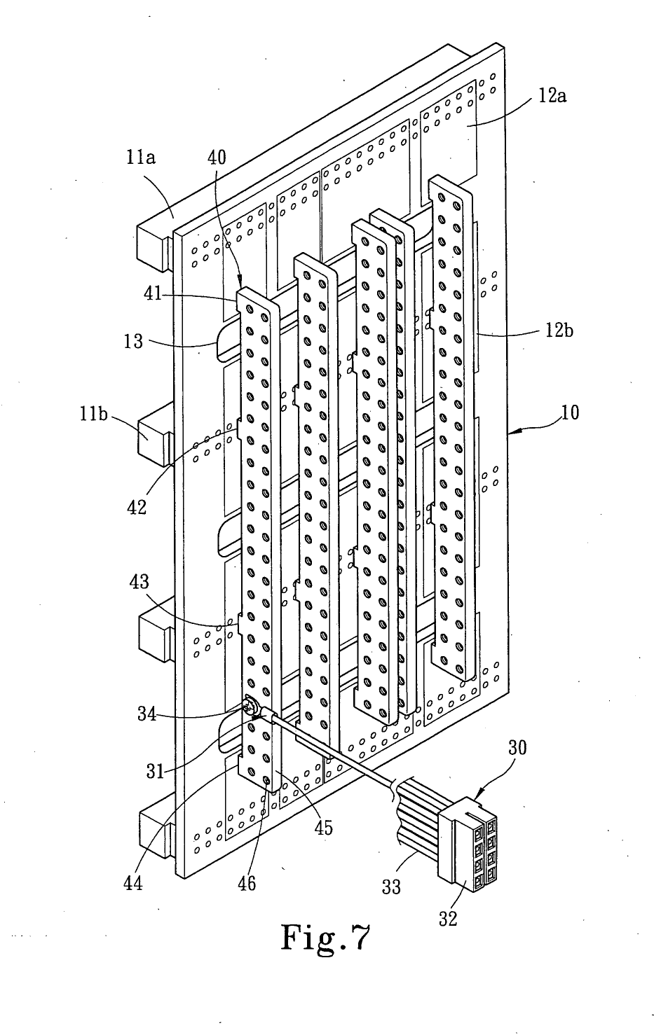

Refer to FIG. 7 for a third embodiment of the invention. The electric bridge 40 is a single piece with a linking section 45 extending to form a terminal 41, 42, 43 and 44 for each electric processing circuit 12a and 12b. The number of the terminal 41, 42, 43 and 44 depends on the number of the electric processing circuit 12a and 12b. In this embodiment, the fastening section 46 on the linking section 45 is a multi-layer design that is expandable according to the number of the power cords 30.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An electric output structure for a multi-layer power supply having a plurality of power supply connection ports on a circuit board to electrically connect to a plurality of power supply devices, each power supply connection port having an electric processing circuit to be integrated through the electric output structure to output electricity, the electric output structure comprising:
at least one electric bridge which includes terminals electrically connecting to the electric processing circuit and a linking section connecting to the terminals, the terminals or linking section having at least one fastening section; and
at least one power cord which has a fastening terminal, an electric output head and a signal line connecting to the fastening terminal and the electric output head, the fastening terminal having a coupling section fastenable to the fastening section through a retaining member.

2. The electric output structure of claim 1, wherein the fastening section has internal screw threads formed therein, and the retaining member has external screw threads formed thereon.

3. The electric output structure of claim 1, wherein the coupling section has two legs to form a fastening zone therebetween to couple with the retaining member.

4. The electric output structure of claim 1, wherein the coupling section is an annular ring having an aperture in the center to couple with the retaining member.
